(19) United States
(12) Patent Application Publication
(10) Pub. No.: US 2002/0095796 A1
(43) Pub. Date: Jul. 25, 2002

(54) Scissors with flexible handle segment

(76) Inventors: Richard A. Whitehall, New York, NY (US); Mitra E. Leyde, New York, NY (US); Donald R. Lamond, Haworth, NJ (US); David E. Evans, Newark, NJ (US)

Correspondence Address: SEYFARTH SHAW, 55 EAST MONROE STREET, SUITE 4200, CHICAGO, IL, 60603-5803, US

(21) Appl. No.: 09/765,160

(22) Filed: Jan. 19, 2001

(51) Int. Cl. B26B 13/20

(52) U.S. Cl. 30/232; 30/341

(57) ABSTRACT

A scissors has pivotally joined metal cutting elements, each having a handle portion including a yoke insert molded in hard plastic inner portions of handle loops. In one of the loops the hard plastic material defines only a part of the loop, terminating in spaced ends which are fixed to a flexible and resilient portion which completes the loop. The other loop has projecting forwardly therefrom a hard plastic finger rest which extends along the handle portion and defines a channel receiving the handle portion of the one loop. Both loops have hard plastic buttons projecting therefrom which abut when the scissors are closed. The flexible and resilient portion of the one loop is formed of a soft, frictional material which also covers outer surfaces of the hard plastic portions of both loops and the finger rest.

### BACKGROUND OF THE INVENTION

This application relates to scissors, particularly scissors of the type which are suitable for household and/or office use. It relates in particular to ergonomically designed scissors.

A common scissors configuration includes two pivotally interconnected lever members, each having a cutting blade at one end and a handle at the other end. The handles respectively define loops, which may be of the same or different sizes and shapes. A typical arrangement has a relatively smaller loop for receiving a user's thumb and a relatively larger loop for receiving some or all of the user's fingers. A finger or fingers which are not accommodated in the finger loop may rest, in use, on the associated handle portion just forwardly of the finger loop. In opening the scissors, the user's thumb typically bears primarily along the rear portion of the thumb loop. The loops are typically formed of a hard rigid material, which may be the same material as the cutting blades, or a different material, such as a hard plastic or the like. A hard smooth material is desired, because it facilitates sliding of the user's fingers and thumb in the loops during use, and enhances durability.

However, the hard, rigid material of the handle loops can cause discomfort to the user's hand in use, particularly during extended use. This is particularly true of a user's thumb, which is the weakest of the user's digits and tends to undergo more movement relative to its associated loop then do the fingers during opening and closing of the scissors.

### SUMMARY OF THE INVENTION

There is disclosed an improved scissors which avoids the disadvantages of prior scissors while affording additional structural and operating advantages.

An important feature of the disclosed scissors is that it is ergonomically designed to minimize discomfort to the user, particularly to the user's thumb.

Another feature is that the scissors provides a flexible and resilient portion on at least one of the handle loops.

Another feature is that the scissors provides an improved gripping surface for a user's fingers which are not accommodated in a finger loop.

A further feature is that the scissors is of relatively simple and economical construction.

Certain ones of these and other features may be attained by providing scissors comprising: two lever members pivotally coupled together at a pivot point and each having a cutting blade and a handle portion, a handle loop fixed to one of the handle portions, the handle loop including a rigid portion having first spaced-apart ends and defining a partial loop, and a flexible and resilient portion having second ends respectively fixed to the first ends for cooperation with the rigid portion to complete the loop.

Further features maybe attained by providing a scissors of the type set forth, wherein each handle portion has a handle loop, at least one of which has the flexible and resilient portion.

Still further features may be attained by providing a scissors of the type set forth which additionally includes a finger rest extending from one of the loops along the associated handle portion.

### BRIEF DESCRIPTION OF THE DRAWINGS

For the purpose of facilitating an understanding of the scissors sought to be protected, there is illustrated in the accompanying drawings a preferred embodiment thereof, from an inspection of which, when considered in connection with the following description, the scissors, its construction and operation, and many of its advantages should be readily understood and appreciated.

FIG. 1 is a side elevational view of a scissors incorporating the above-described features, shown in a closed position;

FIG. 2 is a reduced, perspective view of the scissors of FIG. 1, shown in the open position;

FIG. 3 is a top plan view of the scissors of FIG. 1;

FIG. 4 is a reduced, exploded, perspective view of the scissors of FIG. 1;

FIG. 5 is an enlarged view in vertical section taken along the line 5-5 in FIG. 1;

FIG. 6 is a top plan view of the thumb lever member of the scissors of FIG. 1;

FIG. 7, is an enlarged, fragmentary sectional view taken generally along the line 7-7 in FIG. 6;

FIG. 8 is a top plan view of the finger lever member of the scissors of FIG. 1;

FIG. 9 is an enlarged, fragmentary sectional view taken generally along the line 9-9 in FIG. 8; and

FIG. 10 is an enlarged, fragmentary sectional view taken generally along the line 10-10 in FIG. 8.

### DESCRIPTION OF THE PREFERRED EMBODIMENT

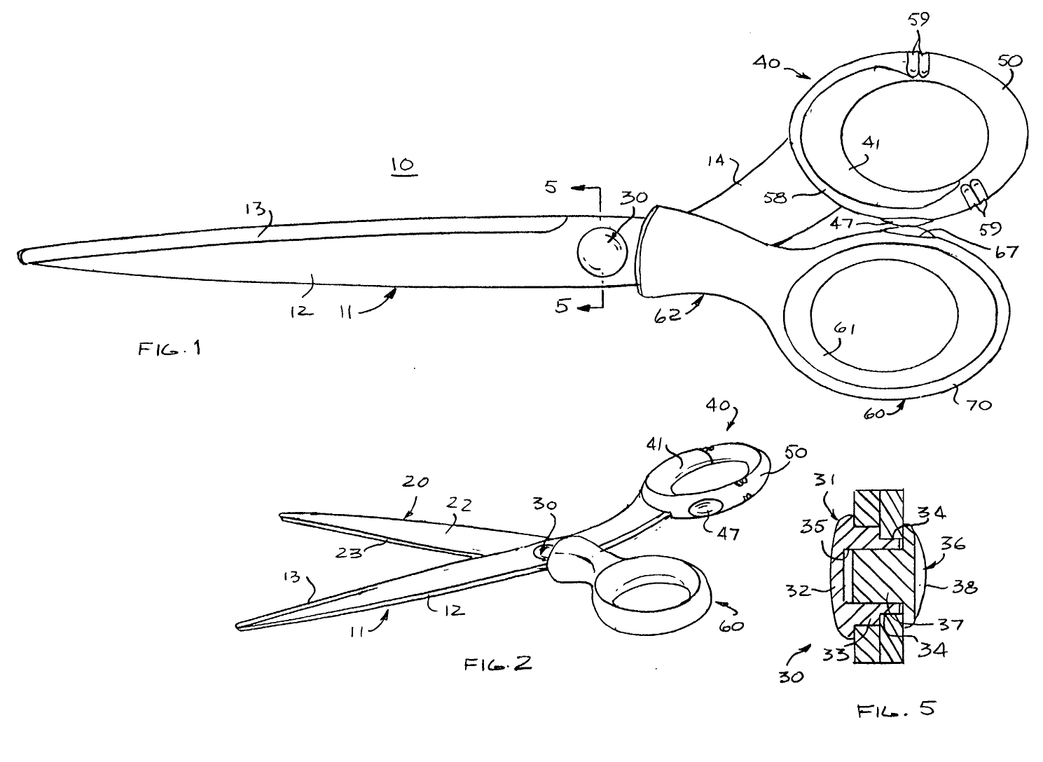

Referring to FIGS. 1-4 of the drawings, there is illustrated a scissors 10 constructed in accordance with the present invention. The scissors 10 has two crossed lever members 11 and 20 pivotally interconnected by a pivot joint 30, the lever member 11 being provided with a thumb-receiving handle loop 40 and the lever member 20 being provided with a finger-receiving handle loop 60. The lever members 11 and 20 are preferably formed of a suitable metal, such as stainless steel, while the handle loops 40 and 60 are preferably formed of non-metallic materials as will be described in greater detail below.

More specifically, referring to FIGS. 4, 6 and 7, the lever member 11 has an elongated cutting blade 12 at one end thereof provided with a cutting edge 13, and has at the other end thereof a handle portion 14 terminating in a yoke 15 defining a pair of tangs 16. Three small holes 17 are formed through the yoke 15, while a larger circular pivot hole 18 is formed through the lever member 11 adjacent to the junction between the cutting blade 12 and the handle portion 14.

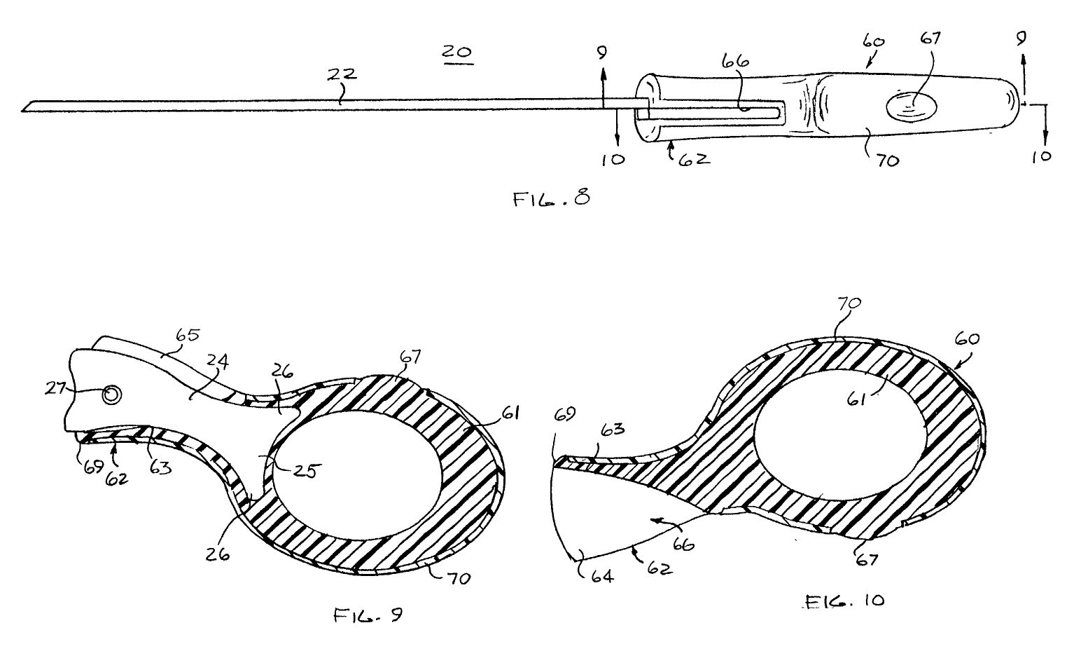

Similarly, referring to FIGS. 4 and 8-10, the lever member 20 has at one end thereof an elongated cutting blade 22 provided with a cutting edge 23, and is provided at the other end thereof with a handle portion 24 terminating in a yoke 25 defining tangs 26. A small hole 27 is formed through the handle portion 24, while an oblong pivot hole 28 having a pair of opposed flat sides is formed through the lever member 20 adjacent to the junction between the cutting blade 22 and the handle portion 24.

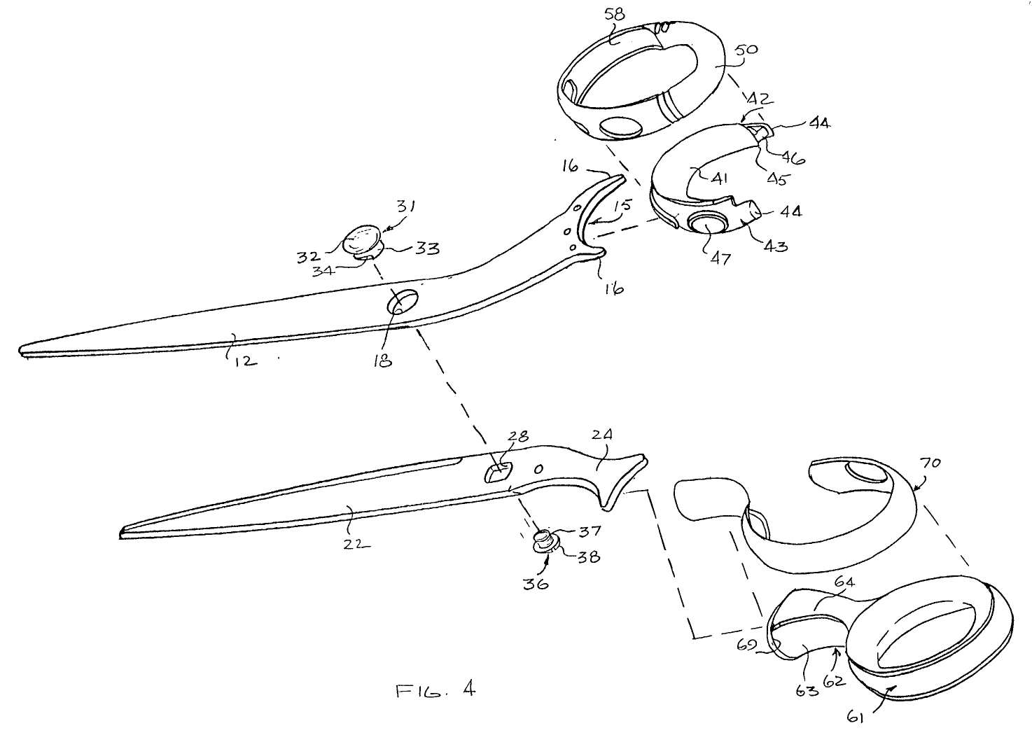

Referring to FIGS. 4 and 5, the pivot joint 30 includes a pivot pin 31 having an enlarged circular head 32 and a short shank 33 with a pair of opposed, flat sides 34 and an internally threaded socket 35. The joint also includes a screw 36 having an externally threaded shank 37 and an enlarged slotted head 38. In assembly, the cutting blades 12 and 22 are arranged back-to-back with the pivot holes 18 and 28 coaxially aligned. The pivot pin 31 is inserted through the aligned pivot holes 18 and 28 from the outside of the cutting blade 12, with the flat sides 34 of the shank 33 respectively disposed for engagement with the flat sides of the pivot hole 28. The screw shank 37 is then inserted from the outside of the cutting blade 22 and threadedly engaged in the socket 35, all in a known manner. Thus, it will be appreciated that the lever member 20 is fixed relative to the pivot joint 30, while the lever member 11 is rotatable about the axis of the pivot joint 30 for movement of the scissors between a closed position, illustrated in FIG. 1 and an open position, illustrated in FIG. 2, all in a well-known manner.

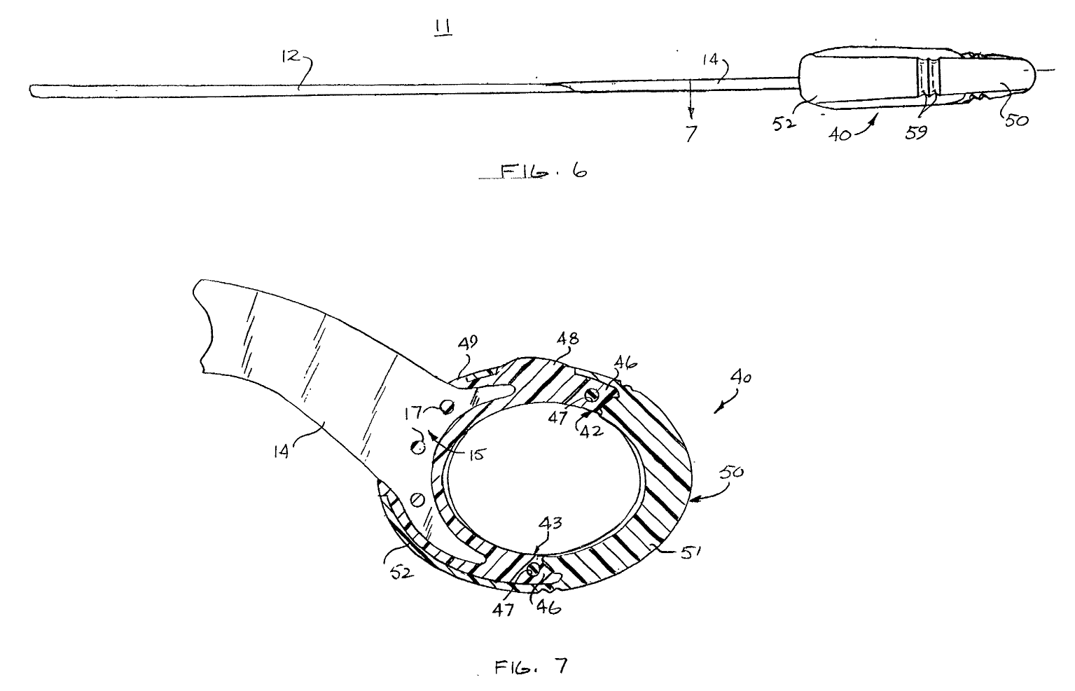

Referring to FIGS. 4 and 7, the thumb-receiving handle loop 40 is of compound construction, including a rigid portion 41 forming the forward portion of the loop adjacent to the yoke 15, and a flexible and resilient portion 50 forming the rearward portion of the loop. More specifically, the rigid portion 41 is preferably formed of a suitable hard, plastic material, such as polypropylene, and is preferably insert molded around the yoke 15, terminating rearwardly of the yoke tangs 16 in spaced-apart ends 42 and 43. Each of the ends 42 and 43 has recessed portions 44 and 45 respectively along the opposite sides thereof leaving a central web 46 having a hole 47 therethrough. The rigid portion 41 also has an outwardly projecting button 48 disposed adjacent to the end 43 and a shoulder 49 encircling the yoke 15.

The flexible and resilient portion 50 is preferably formed of a suitable soft, frictional, cushioning material, such as a rubber-like material of the type sold under the trademark SANTOPRENE, and is preferably overmolded on the rigid portion 41 to form a generally semi-elliptical ring. The flexible and resilient portion 50 has a solid main body 51 which forms the rear end of the handle loop 40. The forward portion 52 of the flexible and resilient portion 50 is generally channel shaped and fills the recessed portions 44 and 45 and the holes 47. The forward portion 52 covers the radially outer surface of the rigid portion 41 except for the button 48 and the shoulder 49 which are respectively received through openings 53 and 54 in the forward portion 52.

It can be seen that the rigid portion 41 and the flexible and resilient portion 50 cooperate to define the complete handle loop 40, which is substantially elliptical in shape. Along the inside of the loop, the forward portion is defined by the hard plastic material of the rigid portion 41, while the rear portion of the loop is defined by the soft, cushioning, frictional material of the flexible and resilient portion 50. The outside of the loop 40, on the other hand, except for the button 48 and the shoulder 49 is substantially formed by the material of the flexible and resilient portion 50. Annular grooves 59 may be formed in the flexible and resilient portion 50 adjacent to each of the ends 42 and 43.

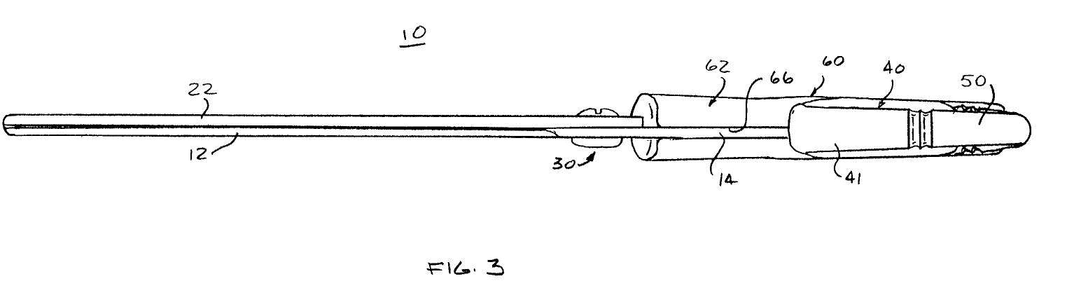

Referring in particular to FIGS. 4, 9 and 20, the finger-receiving handle loop 60 is formed entirely of a rigid plastic body 61, which is preferably formed of the same material as the rigid portion 41, and is insert molded over the yoke 25 and forms a generally elliptical loop projecting rearwardly from the yoke 25. The plastic body 61 also includes a finger guard 62, which projects forwardly around the handle portion 24 and is generally channel-shaped, having a bight 63 and a pair of upstanding side walls 64 and 65, the latter being adhered to the outer surface of the lever member 20. The side walls 64 and 65 cooperate to define a channel 66 therebetween, which exposes a portion of the inner side surface of the handle portion 24 and is wide enough to receive therein the handle portion 14 of the lever member 11, as can best be seen in FIGS. 3 and 8. The body 61 has a button 67 projecting outwardly therefrom. An outwardly projecting shoulder or flange 69 is disposed at the distal end of the finger guard 62. A flexible and resilient covering 70, preferably formed of the same material as the flexible and resilient portion 50 and overmolded over the rigid plastic body 61, covers the radially outer surfaces of the plastic body 61 over an arc of about 300°, except for the button 67, and covers the bight 63 of the finger guard 62. The button 67 extends through an opening 71 in the covering 70.

Accordingly, it will be appreciated that the hard plastic material of the plastic body 61 is exposed along the inside of the loop 60 and along the side surfaces thereof, while the flexible and resilient covering 70 is exposed along most of the outer periphery of the loop 60 and along the bight 63 of the finger guard 62.

It can be seen that, in assembly, when the lever members 11 and 20 are arranged for pivotal interconnection, the handle portion 14 of the lever member 11 is freely received in the channel 66 of the finger guard 62 and accommodates free pivotal movement of the lever members 11 and 20 relative to each other. The buttons 48 and 67 are arranged for abutting engagement with each other when the scissors 10 are disposed in the closed position illustrated in FIG. 1, to minimize wear of the scissors at these locations.

It will be appreciated that, in use, when a user's thumb is received through the handle loop 40, the exposed hard plastic material along the front side of the loop 40 accommodates free sliding movement of the user's thumb, while the flexible and resilient portion at the rear end of the loop cushions and yields with movement of the user's thumb and the scissors-opening direction to minimize discomfort to the user's thumb. The user's fingers which are received through the handle loop 60 are freely slidable along the hard plastic material of the rigid body thereof, while a user's finger or fingers which are hooked beneath the finger guard 62 are cushioned by the flexible and resilient covering 70. Also, the presence of the flexible and resilient material along the outer peripheries of the loops 40 and 60 provides good frictional gripping surfaces to facilitate handling of the scissors 10.

From the foregoing, it can be seen that there has been provided an improved scissors of simple and economical construction with uniquely ergonomically designed handle loops which minimize discomfort to a user's thumb, while providing free sliding movement of the thumb and fingers through the loops and affording a cushioned and frictional external gripping surface to facilitate handling of the scissors.

While particular embodiments have been shown and described, it will be obvious to those skilled in the art that changes and modifications may be made without departing from the subject matter sought to be protected in its broader aspects. The matter set forth in the foregoing description and accompanying drawings is offered by way of illustration only and not as a limitation. The actual scope of the subject matter sought to be protected is intended to be defined in the following claims, when viewed in their proper perspective based on the prior art.

We claim:

1. Scissors comprising:
two lever members pivotally coupled together at a pivot point and each having a cutting blade and a handle portion, and
a handle loop fixed to one of the handle portions,
the handle loop including a rigid portion having first spaced-apart ends and defining a partial loop, and a flexible and resilient portion fixed to the rigid portion for cooperation therewith to complete the loop.

2. The scissors of claim 1, wherein said levers are formed of metal.

3. The scissors of claim 2, wherein the one of the handle portions has a yoke projecting therefrom.

4. The scissors of claim 3, wherein the rigid portion of the handle loop is formed of a hard plastic material, the yoke being embedded in the rigid portion.

5. The scissors of claim 4, wherein the rigid portion is insert molded around the yoke of the one handle portion.

6. The scissors of claim 1, wherein the flexible and resilient portion is formed of a relatively soft frictional material to provide a good gripping surface.

7. The scissors of claim 6, wherein the flexible and resilient portion is overmolded on the first ends.

8. The scissors of claim 7, wherein the soft frictional material substantially covers the rigid portion along only the outside of the loop.

9. Scissors comprising:
two lever members pivotally coupled together at a pivot point and each having a cutting blade and a handle portion, and
two handle loops respectively fixed to the handle portions,
each of the handle lops including a rigid portion,
the rigid portion of at least one of the handle loops having first spaced-apart ends and defining only a partial loop,
the at least one handle loop including a flexible and resilient portion fixed to the rigid portion for cooperation therewith to complete the at least one of the loops.

10. The scissors of claim 9, wherein each of levers is formed of metal.

11. The scissors of claim 9, wherein the rigid portion is formed of a hard plastic material.

12. The scissors of claim 11, wherein only the one handle loop includes the flexible and resilient portion, another handle loop having hard plastic material along the entire length of the loop.

13. The scissors of claim 12, wherein each of the loops has a hard plastic button projecting therefrom, the buttons being engageable when the cutting blades are in a closed position relative to each other.

14. The scissors of claim 13, wherein the flexible and resilient portion is formed of a relatively soft frictional material to provide a good gripping surface.

15. The scissors of claim 14, wherein the soft frictional material substantially covers the rigid portion along only the outside of the loop.

16. Scissors comprising:
two lever members pivotally coupled together at a pivot point and each having a cutting blade and a handle portion,
two handle loops respectively fixed to the handle portions, and
a finger rest integral with one of the loops and extending therefrom along a first one of the handle portions and defining a channel receiving a second one of the handle portions.

17. The scissors of claim 16, wherein each of the handle loops includes a rigid portion formed of a hard plastic material.

18. The scissors of claim 17, wherein the rigid portion of at least one of the handle loops has first spaced-apart ends and defines only a partial loop, the at least one handle loop including a flexible and resilient portion formed of a relatively soft frictional material and fixed to the rigid portion for cooperation therewith to complete the at least one of the loops.

19. The scissors of claim 18, wherein only the one handle loop portion includes the flexible and resilient portion.

20. The scissors of claim 19, wherein in another of the loops the rigid portion extends along the entire length of the loop.

21. The scissors of claim 20, wherein the soft frictional material substantially covers the rigid portion along only the outside of the loop.

22. The scissors of claim 16, wherein the finger rest is molded onto the first one of the handle portions.
